(19) United States
(12) Patent Application Publication
(10) Pub. No.: US 2018/0236470 A1
(43) Pub. Date: Aug. 23, 2018

(54) SPRAYING DEVICE AND METHOD FOR COATING SAMPLES

(71) Applicant: SunChrom Wissenschaftliche Gerate GmbH, Friedrichsdorf (DE)

(72) Inventor: Günes BARKA, Friedrichsdorf (DE)

(73) Assignee: SunChrom Wissenschaftliche Gerate GmbH, Friedrichsdorf (DE)

(21) Appl. No.: 15/751,865

(22) PCT Filed: Apr. 15, 2016
(86) PCT No.: PCT/EP2016/058451

§ 371 Date: Feb. 11, 2018

(30) Foreign Application Priority Data
Aug. 10, 2015 (DE) 10 2015 113 170.6

(51) Int. Cl. B05B 7/06; H01J 49/04

(52) U.S. Cl. CPC B05B 7/066; B05B 5/025; H01J 49/0418

(57) ABSTRACT

The spraying device serves for spraying samples with a solution, wherein a liquid feed for the metered feeding of the solution and a gas feed are provided which are connected via supply lines to a nozzle head (10) which has a gas outlet (36) and a liquid outlet (16) in order to spray the solution. In order, after drying, to allow a formation of relatively small crystals of the matrix in a coating which is as homogeneous as possible, it is proposed that the liquid outlet (16) is provided at the end of a capillary line (14) which projects beyond the gas outlet (36).

The present invention relates to a spraying device for spraying samples with a solution, wherein a liquid feed, for the metered feeding of the solution, and a gas feed are provided and are attached via supply lines to a nozzle head which has a gas outlet and a liquid outlet in order to atomize the solution.

Spraying devices of this kind are used in the MALDI (Matrix Assisted Laser Desorption Ionization) technique. When this technique is applied to tissue samples, it is referred to as MALDI imaging. In the field of imaging mass spectrometry, it has assumed a pioneering role and has become established over a period of about 10 years in cancer research, pharmaceutical development and protein research. The advantage of the MALDI technique is that the tissue samples can be prepared for the test without great effort, and it is not just freshly frozen samples that can be made available for this new and very sensitive test method, but also samples fixed by formalin and samples embedded in silicone, hence samples that can be kept for a practically unlimited time, and likewise, for example, very old sample material, which can be as much as 100 years old or more.

The basis of the MALDI technique is that the tissue sections are placed on steel plates designated as targets or on slides to which they permanently adhere after drying and then fix themselves. The sections are then coated with what is in most cases a polar organic compound which is designated as a matrix and which has the property of absorbing light, upon irradiation with laser beams in the UV range, and of then evaporating under the high energy input. In the process, substances of the tissue sample which are in fact not usually able to evaporate and which would burn under normal heating are also drawn into the vapor phase. However, as a result of the extremely rapid evaporation, it is possible to evaporate such samples. These molecules are ionized in an electric field and recorded by a mass spectrometer. They are then separated by charge and size in these mass spectrometers, wherein software decodes and identifies the composition from these two parameters.

Various methods are known for applying the matrix to the tissue samples, and the chosen method can depend on the analytes that are to be examined or detected. It should be noted in particular that biomolecules or molecules that are difficult to evaporate require extraction and installation into the crystal structure of the matrix in order to be able to be evaporated in a manner that allows them then to be evaluated by means of the mass spectrometer. Other compounds such as lipids, as readily evaporatable substances, require only a simple coating without extraction. For the latter case, sublimation with deposition of the matrix directly from the gas phase already represents an application method with a very fine crystal structure, but it is not suitable for extraction, since no liquid phase is present. It is also a disadvantage that a complete surface alongside the sample is also coated, not just the sample itself, as a result of which there is a high level of consumption of matrix solution, which is crucial in particular in the case of expensive matrices. In any case, only a few matrices are suitable for this method, and they cannot be used for enzyme solutions, for example.

However, in order to be able to effect extraction in the case of coating by sublimation, objects coated by sublimation are stored in a water-saturated environment for 24 to 72 hours, wherein a certain amount of extraction takes place on account of the ambient humidity. The extremely long sample preparation time stands in the way of widespread use of this method.

Of the remaining spraying methods, for example manual spraying, ultrasonic spraying or electrospraying, particular mention must be made of the modified airbrush method in which an optimized spraying head is furnished with an exact amount of liquid per unit of time. Otherwise, such a spraying head, as the name suggests, uses the airbrush technique in which the air stream entrains the liquid according to the ejector principle and finely disperses it. A method of this kind is eminently suitable for extraction, wherein the attainable crystal sizes, after drying of the matrix, are within a size range of 30 to 100 μm.

The resolution in MALDI imaging is determined by the crystal size of the matrix and by the laser diameter. The lower the resolution of these two parameters, the more detailed the information obtained concerning the tissue, e.g. liver, kidneys, skin and brain and all other internal organs and/or their fine structure. This permits a wealth of new information, for example concerning the development of a cancer or the new compounds that form as a result of the cancer, which in turn permits early detection of the disease.

In pharmaceutical research, very detailed information is obtained concerning the distribution of a medicament in the living body, its metabolites and its excretion from the body.

Recent developments in laser technology have created dimensions of ca. 1 μm for the laser diameters. The crystal sizes hitherto applied by the conventional spraying methods cannot keep up with this development. As has already been mentioned, the limit lies in a size range of 30 μm to 100 μm as smallest crystal size, particularly when an extraction is necessary, if the aim is to detect relatively large molecules such as peptides or proteins in a molecular weight range of >100 to over 100,000 Dalton. However, if the crystal size lies in a size range of 30 μm upward, this has the consequence that, even if the laser beam has a diameter of ca. 1 μm, the complete crystal evaporates, such that the resolution is in this case determined by the matrix crystal size and not by the laser diameter.

The object of the present invention is to improve a spraying device of the type mentioned at the outset, so as to permit a formation of relatively small crystals of the matrix in the coating after drying. The coating is also intended to be as homogeneous as possible in order to permit the detection of the molecules not only qualitatively but also semi-quantitatively or quantitatively.

The object of the present invention is achieved by a spraying device of the type mentioned at the outset, in which the liquid outlet is provided at the end of a capillary line which projects, for example centrally, beyond the gas outlet.

It has been found that with the spraying device according to the invention, on account of the liquid outlet projecting beyond the gas outlet, a particularly fine droplet size is attainable which ultimately leads to a matrix layer on the sample, which after drying has a relatively small crystal size, with homogeneous layer formation. Surprisingly, the effect is obtained by the gas outlet specifically being set back in relation to the liquid outlet, such that the gas swirls before reaching the liquid and no longer entrains it as before according to the ejector principle, and instead the fine droplet formation is effected in the swirled gas.

Suitable gases are air or also nitrogen, depending on the nature of the matrix solution to be sprayed and the sample to be tested.

In a particularly preferred embodiment of the invention, provision is made that the end of the capillary line is tapered at its outer circumference, preferably conically tapered. It has been found that this measure permits a particularly fine droplet formation, since the taper, preferably of conical shape, deflects the swirling stream of gas particularly effectively in the direction of the liquid outlet.

In any case, irrespective of the design of the end of the capillary line, there is an active feed of the matrix solution, e.g. by means of a suitable pump which is able to convey the very small amounts of liquid that are needed when applying the layers. Typical amounts of liquid are discussed below in the context of the illustrative embodiments.

In a preferred embodiment, the gas outlet is formed by an annular gap between the outer wall of the capillary line and a guide hose or guide tube. The guide hose or the guide tube serves at the same time to stabilize the sensitive capillary line, which is generally designed as a quartz capillary.

The guide hose or the guide tube, which can be made of PEEK (polyether ether ketone) for example, can in turn be stabilized by a larger diameter, wherein ultimately the guide tube and/or the capillary line are preferably held in a gastight manner in a housing. On the one hand, the housing has the role of exactly defining the position of the nozzle head and, on the other hand, the housing preferably has a gas port for the gas feed, wherein a gas passage is provided in an annular gap between the guide hose or guide tube and the capillary line in the housing. In this way, the housing has the function of leading the stream of gas from the gas feed into the annular gap between the guide hose or guide tube and the capillary line.

The capillary line generally extends all the way through the housing and, at its other end, is connected to an aforementioned delivery pump for the liquid feed, wherein it is also possible to use, instead of a pump, a dispenser with a suitably high resolution, for example 24,000 steps per syringe filling. In order to close the rear output of the capillary line from the housing in a gas-tight manner, a stopper is preferably provided at the side directed away from the liquid spraying head and closes the housing in a gastight manner against the outer wall of the capillary line.

To ensure that the aforementioned positioning of the nozzle head can be carried out particularly exactly, the housing preferably has a shoulder which is arranged at a defined distance from the liquid outlet. The liquid outlet, with its exact position, defines the position of the nozzle head.

The nozzle head is preferably held on a moving device which allows the position of the nozzle head to be moved in the X, Y and/or Z direction. In principle, the possibility of movement in the X and Y directions is more important, since it is also possible to work if appropriate with a fixed position, i.e. a fixed distance of the liquid outlet from the sample surface.

The nozzle head is brought to a defined position in relation to the tissue surface, for example with the aid of the above-described shoulder on the housing.

The present invention also relates to a method for coating samples by spraying with a solution using the above-described spraying device. The latter is used such that the sample is sprayed several times in succession, wherein a subsequent spraying process is carried out only when the previously applied layer has dried off.

It has been found that by applying the spray solution several times, with intermediate drying intervals, it is possible to avoid the undesired effects that hitherto occurred if the amount of liquid was too great, namely where relatively small molecules leave their original position and start to diffuse in different directions, such that ultimately the precision of the position information in the mass spectrometry is lost. By means of the layer by layer application, a 1.-3., very thin layer in the manner of a fixing layer can be used which safeguards the position information and on the other hand forms a kind of absorbent substrate for further layers which, with a suitable amount of matrix solution, are then also suitable for achieving the desired extraction of relatively large molecules in the desired manner into the matrix structure. Accordingly, in a preferred embodiment of the method, the first layer applied is sprayed using a relatively small amount of solution per surface area, and the amount is increased in the subsequent layers until a defined amount of matrix per surface area is achieved, and said amount of solution per surface area is applied several times again for the last layers. A typical number of layers is in the range of 5 to 10, for example 8 layers, such that overall an expedient thickness of the matrix is obtained which, upon irradiation with the laser, then evaporates locally on a surface area reduced to the attained crystal size. The first 1-3 layers, which are sprayed using the relatively small amount of solution per surface area, dry off very quickly, and there is therefore no fear of relatively small molecules changing position.

For example, proceeding from a first amount of solution per surface area for the first layer, the amount can be doubled upon application of the second layer and trebled upon application of the third layer until, at the third to sixth layer, a maximum is reached that is used for all subsequent layers.

Since a surface area with a diameter of 2 mm, for example, can generally be sprayed by means of a spraying device configured in a conventional manner with a suitable geometry of the spraying head, it is expedient, in the case of relatively large samples, to spray the latter line by line using a device with mobility in the X and Y direction for application of a layer. After the sample has been sprayed line by line and a layer has accordingly been fully applied, the spraying head then travels back to the starting position and repeats the application line by line for the next layer.

An illustrative embodiment of the invention is discussed in more detail below with reference to the attached drawings, in which:

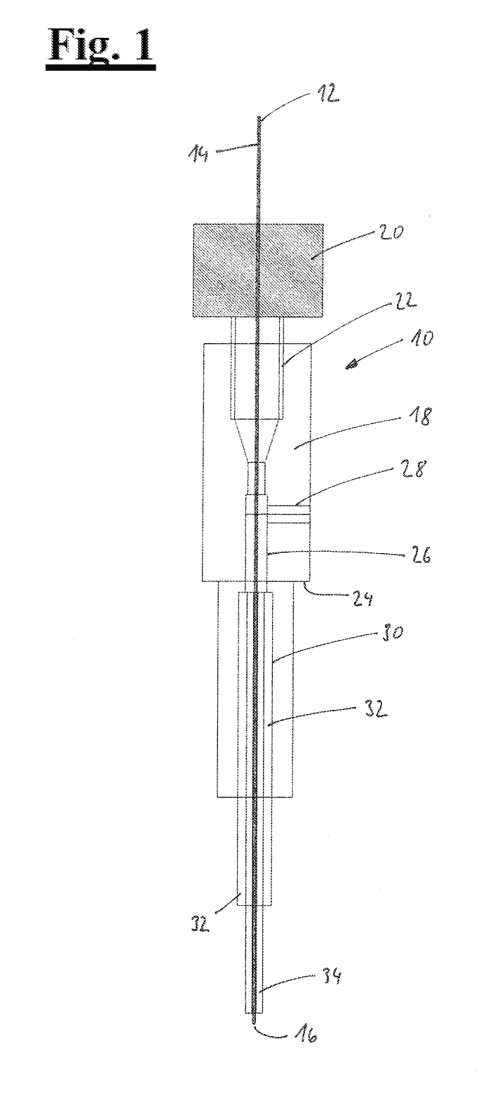

FIG. 1 shows an overall view, in cross section, of a spraying head of a spraying device;

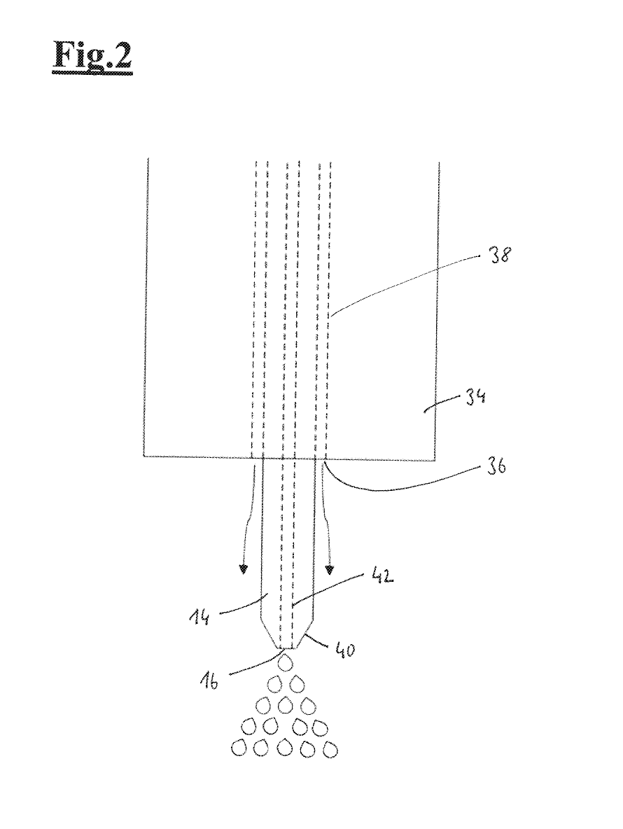

FIG. 2 shows a detailed view of the output regions of the spraying head;

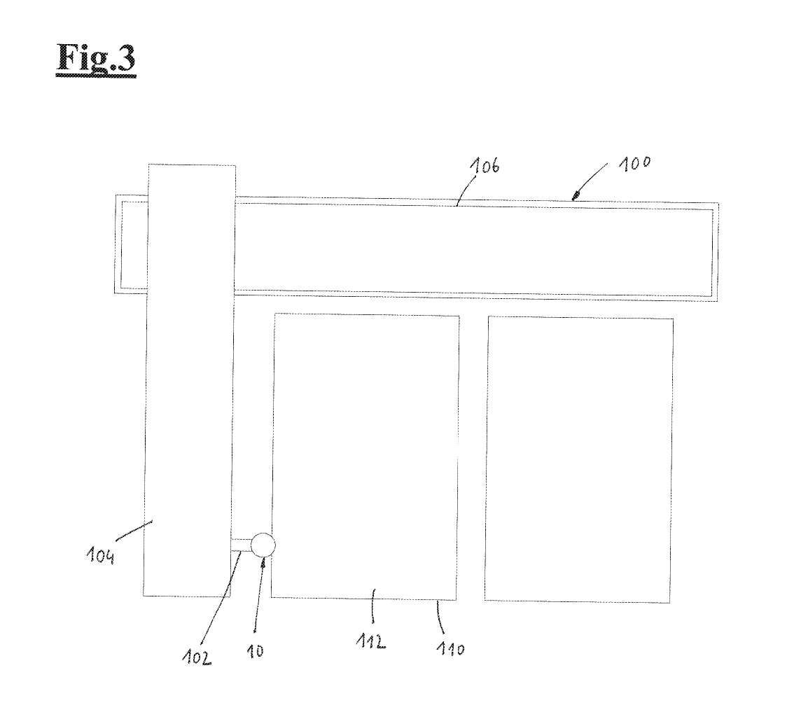

FIG. 3 shows a schematic view of a spraying device with an adjustable spraying head.

FIG. 1 shows a nozzle head 10, which can also be designated as a spraying head. The nozzle head 10 is connected, via a rear end 12 of a quartz capillary 14 as capillary line, to a liquid feed (not shown in any detail). This liquid feed can be provided by a constant-delivery syringe pump or by a dispenser with a very high resolution of 24,000 steps per syringe filling, in order to convey very exact amounts of liquid through the capillary line of the quartz capillary 14 to a liquid output 16 (see also FIG. 2).

The quartz capillary line 14 is routed through a housing 18, which is closed at its rear end with the aid of a union nut 20, wherein the union nut 20 engages in a thread 22 in the housing 18 and seals the housing against the outer circumference of the quartz capillary 14. The housing itself is designed in a stepped shape with a shoulder 24, the function of which is discussed in more detail below.

The housing is provided internally with a central bore 26, the latter communicating with a radial gas port 28 that is to be connected to a gas feed (not shown). By suitable pumping means, the gas feed ensures the delivery of air or another suitable gas, e.g. nitrogen, at a pressure of usually 2 to 3 bar, which is kept constant during operation, although other pressure values can also be realized.

At the end of the housing 18 opposite the union nut 20, a first guide hose 32 sits in a widened bore portion 30, said guide hose 32 also being able to be designed as a guide tube inside which a further guide hose 34 is introduced in a pressure-tight manner. The second guide hose 34 encloses the outer circumference of the quartz capillary 14 with an annular gap. That is to say, between the second guide hose 34 and the quartz capillary, there is a gas passage between the bore 26 of the housing 10 and a gas outlet 36 (see FIG. 2) at the end of the second guide hose 34, at the center of which the quartz capillary 14 projects by a defined distance beyond the end of the second guide hose 34.

As will be clearly seen from FIG. 2, the annular gap 38 is provided to ensure that the gas fed through the gas port 28 is blown out at the end of the second guide hose 34, as is indicated by the arrows. The liquid output 16 is here realized at a distance from the gas output 36 and is depicted by the sketched droplets. As a result of the distance between the gas outlet 36 and the liquid outlet 16, the stream of gas can easily swirl, wherein the end of the glass capillary 14 is provided with a conical taper 40 by which the swirling stream of gas is conveyed in the direction of the metered stream of liquid issuing from the liquid output 16. This conical taper, which can also be convex, permits the formation of particularly fine droplets, wherein the stream of gas conveys the fine liquid droplets farther in the direction of a sample arranged underneath the liquid outlet 16.

The nozzle head shown in FIGS. 1 and 2 is mounted in a spraying device 100, wherein the shoulder 24 rests in a defined position of a seat, such that the liquid outlet 16 lies at a defined distance from metal targets 110 which are arranged on a table and on which tissue 112 that is to be sprayed is placed in preparation for further tests. The seat 102 of the nozzle head 10 is arranged on a carrier 104 so as to be movable laterally in a Y direction, which carrier 104 is in turn mounted on a rail 106 so as to be movable in an X direction, such that the nozzle head is adjustable in the X and Y directions by movement of the seat 102 on the carrier 104 and movement of the carrier 104 on the rail 106. The seat 102 can be adjustable in the Z direction in order to be able to set the liquid outlet 16 at its distance to the targets 110 or prepared glass supports.

Generally, however, an adjustment of the distance between the spraying head 10 and the targets 110 is not necessary during the actual spraying procedure.

Normally, the tissue 112 is sprayed by means of the nozzle head 10 traveling line by line over the surface area to be sprayed, since generally the region covered by the spray jet is smaller than the surface area of the tissue that is to be sprayed. Typically, when traveling line by line, the sprayed matrix solution covers a strip-shaped surface area with a width of approximately 2 mm.

An illustrative embodiment is described in detail below in which some parameters are stated explicitly, even though these may vary within a wide range in the context of the invention.

A matrix solution was atomized that had been mixed, in the region of the nozzle head 10, with a stream of air delivered at a constant pressure of 2.5 bar. The external diameter of the selected quartz capillary was 280 μm, wherein an annular gap with a height of 60 μm was provided between the second guide hose 34 and the external diameter of the quartz capillary 14, i.e. the internal diameter of the second guide hose made of PEEK was 400 μm. The quartz capillary 14 had an inner channel 42 with a diameter of 75 μm.

At a fixed distance of 40 mm between the liquid output and the surface of the target 110, the latter was sprayed line by line until a desired surface area had been sprayed completely with the matrix solution. With the chosen nozzle geometry and at the chosen gas pressure, a region of ca. 2 mm is in this case sprayed directly, wherein the line spacings are chosen such that there is only minimal overlapping of adjacent sprayed lines, so as to avoid deviating layer thicknesses in the overlap region.

When applying a first layer, a liquid feed of 10 μl per minute was chosen, wherein the speed of movement was 200 cm per minute.

After application of the first layer, a second layer was applied by atomization which, with otherwise identical parameters, had been carried out with doubling of the liquid feed to 20 μl per minute. A third layer was applied with 30 μl per minute, a fourth with 40 μl per minute, wherein a total of 8 layers were applied which, starting from the fourth layer, had all been applied with a liquid feed of 40 μl per minute.

An electron microscope test of the layer revealed that matrix crystals of a very constant crystal size in the range of 130 to 140 nm had formed. With such crystal sizes, the sample was eminently suitable for further testing in the context of the latest MALDI technique using a laser with a light beam focused to 1 μm. By means of the small crystals, the resolution of the mass spectroscopy test is defined by the extremely small cross section of the laser beam of 1 μm, which is below the size of a human cell of up to 10 μm, such that in the context of this test the tissue could be analyzed by individual cells.

The described illustrative embodiment is not restricted in terms of its key data. In particular, the dimensions of the quartz capillary and of the guide hose can differ considerably, and the amount of liquid can also differ considerably from the stated values depending on the nature of the matrix solution to be atomized. As regards the gas feed too, deviations from the chosen pressure are possible in order to be able to apply correspondingly different layers in accordance with the desired test.

1. A spraying device for spraying samples (112) with a solution, wherein a liquid feed, for the metered feeding of the solution, and a gas feed are provided and are attached via supply lines to a nozzle head (10) which has a gas outlet (36) and a liquid outlet (16) in order to atomize the solution, characterized in that the liquid outlet (16) is provided at the end of a capillary line (14) which projects beyond the gas outlet (36).

2. The spraying device as claimed in claim 1, characterized in that the end of the capillary line (14) is tapered at its outer circumference.

3. The spraying device as claimed in claim 1, characterized in that the gas outlet (36) is formed by an annular gap between an outer circumference of the capillary line (14) and a guide hose (34) or guide tube.

4. The spraying device as claimed in claim 1, characterized in that the guide hose (34) and/or the capillary line (14) are held in a gastight manner in a housing (18).

5. The spraying device as claimed in claim 4, characterized in that the housing (18) has a gas port (28) for the gas feed, and a gas passage is provided in an annular gap between the guide hose or tube (34) and the capillary line (14) in the housing.

6. The spraying device as claimed in claim 4, characterized in that the housing (10), at a side directed away from the liquid outlet (16), is provided with a threaded stopper (20) which closes the housing (10) in a gastight manner against the outer wall of the capillary line (14).

7. The spraying device as claimed in claim 4, characterized in that the housing has a shoulder (24) which is arranged at a defined distance from the liquid outlet (16).

8. The spraying device as claimed in claim 1, characterized in that the nozzle head (10) is held on a moving device (100) which allows the position of the nozzle head (10) to be moved in the X, Y and/or Z direction.

9. A method for coating samples (112) by spraying with a solution using a spraying device as claimed in claim 1, characterized in that the sample (112) is sprayed several times in succession, wherein a subsequent spray application is carried out only when the previously applied layer has dried off.

10. The method as claimed in claim 9, characterized in that the first layer applied is sprayed with a relatively small amount of solution per surface area, and the amount is increased in the subsequent layers until a defined amount of solution per surface area is reached, which is applied again for the last layer or applied several times again for several layers.

11. The method as claimed in claim 10, characterized in that a first amount of solution per surface area for the first layer is doubled upon application of the second layer, trebled upon application of the third layer and, if appropriate, further increased up to a maximum in a further layer, which maximum is used in the application for all subsequent layers.

12. The method using a device as claimed in claim 8, characterized in that the sample is sprayed line by line for the application of a respective layer.
